(19) United States
(12) Patent Application Publication
(10) Pub. No.: US 2004/0195262 A1
(43) Pub. Date: Oct. 7, 2004

(54) Liquid cooler and dispenser

(76) Inventor: Donald Timothy Hart, San Antonio, TX (US)

Correspondence Address: LAW OFFICES OF CHRISTOPHER L. MAKAY, 1634 Milam Building, 115 East Travis Street, San Antonio, TX, 78205, US

(21) Appl. No.: 10/405,425

(22) Filed: Apr. 2, 2003

(51) Int. Cl. B67D 5/62; G01F 11/00

(52) U.S. Cl. 222/1; 222/146.6

(57) ABSTRACT

A method and apparatus for on demand chilling and dispensing of product from a commercially available product package is disclosed. The product dispenser includes a product container positioned on a housing that is adapted to receive thermal cooling media. The product dispenser further includes a container cap attachable to a portal of the product container and a first end of a dispense tubing. A second end of the dispense tubing is connectable to a dispensing valve mountable to the housing, thereby regulating delivery. The thermal cooling media resides in the housing, thereby cooling the dispense tubing and its contents. Also provided are provisions for inclusion of a product container as part of the dispenser that can be filled and refilled. Further provisions include the ability to adapt to varying product container portal sizes and varying product container sizes, as commonly seen in commercial product packaging. Methods provided include installation of the product container and operation of the product dispenser.

### BACKGROUND OF THE INVENTION

1. Field of the Invention

The present invention relates to dispensing chilled fluids and, more particularly, but not by way of limitation, to a wine cooler and dispenser that provides on demand chilling and dispensing.

2. Description of the Related Art

The packaging of wine for sale and distribution varies from bottles to bag-in-box arrangements. More expensive wines produced in limited quantities are generally packaged in bottles sealed with a cork. Less expensive wines produced in higher volumes may be packaged in bag-in-box arrangements including dispensing spigots. Alternatively, some less expensive wines may be packaged in large bottles sealed with a removable cap.

Regardless of the packaging, wine is often chilled in a refrigerator. Large gatherings thus present several problems when multiple larger bottles of wine must be chilled. Insufficient refrigerator space can result in a lack of adequate chilled wine for the gathering. Furthermore, even when there is ample refrigerator space, an incorrect estimate of the required number of bottles can occur. In either instance, the persons attending the gathering are forced to consume unchilled wine or chill the wine through the addition of ice directly into wine glasses.

Accordingly, there is a long felt need for a cost effective on demand chilling and dispensing apparatus for wine.

### SUMMARY OF THE INVENTION

In accordance with the present invention, a method and apparatus for dispensing product includes a product container positioned on a housing. The product dispenser further includes a container cap attachable to a portal of the product container and a first end of a dispense tubing. A second end of the dispense tubing is connectable to a dispensing valve mountable to the housing. A thermal cooling media resides in the housing, thereby cooling the dispense tubing and its contents.

The invention provides provisions for adapting to varying product container portal sizes as commonly seen in commercial product packaging. The invention further provides for accommodating varying product container sizes. Also provided are provisions for inclusion of a product container as part of the product dispenser to be filled and refilled when emptied. Methods are provided for the installation and operation of the product dispenser, including product container installation, product container changeout, and dispensing of product from the product dispenser.

In summary, the product dispenser allows for on-demand dispensing of a chilled product directly from the product container. The product flowpath includes the product container, the container cap, the dispense tubing, and the dispensing valve. The product is cooled as it sits in the housing or as it flows through the dispense tubing to the dispensing valve. Use of this apparatus eliminates the need for prechilling of product before consumption.

It is therefore an object of this invention to provide on-demand dispensing and chilling of a product directly from the product packaging.

It is another object of this invention to provide for varying sizes of product container portals.

It is a further object of this invention to accommodate varying product container sizes.

It is still a further object of this invention to provide the ability to remove or changeout partially evacuated product containers with minimal waste.

Still other objects, features, and advantages of the invention will become evident to those of ordinary skill in the art in light of the following.

### BRIEF DESCRIPTION OF THE DRAWINGS

FIG. 1 is a side view of the product dispenser with cooling media according to the preferred embodiment.

FIG. 2 is a side view of the product dispenser according to the preferred embodiment.

FIG. 3 is front view of the product dispenser with the product bottle removed according to the preferred embodiment.

FIG. 4 is a perspective view of the product dispenser lids according to the preferred embodiment.

FIG. 5 is a method flowchart for use of the product dispenser according to the preferred embodiment.

FIG. 6 is a method flowchart for changing of the product container according to the preferred embodiment.

### DETAILED DESCRIPTION OF THE PREFERRED EMBODIMENT

As required, detailed embodiments of the preferred invention are disclosed herein: however, it is to be understood that the disclosed embodiments are merely exemplary of the invention, which may be embodied in various forms. It is further to be understood that the figures are not necessarily to scale, and some features may be exaggerated to show details of particular components or steps.

The invention of discussion is an apparatus for chilling and dispensing fluids as needed for consumption. The device provides for installation and removal of empty and partially empty product containers. The device further provides for chilling a fluid as it is drawn to the point of dispense, therein eliminating pre-chilling requirements.

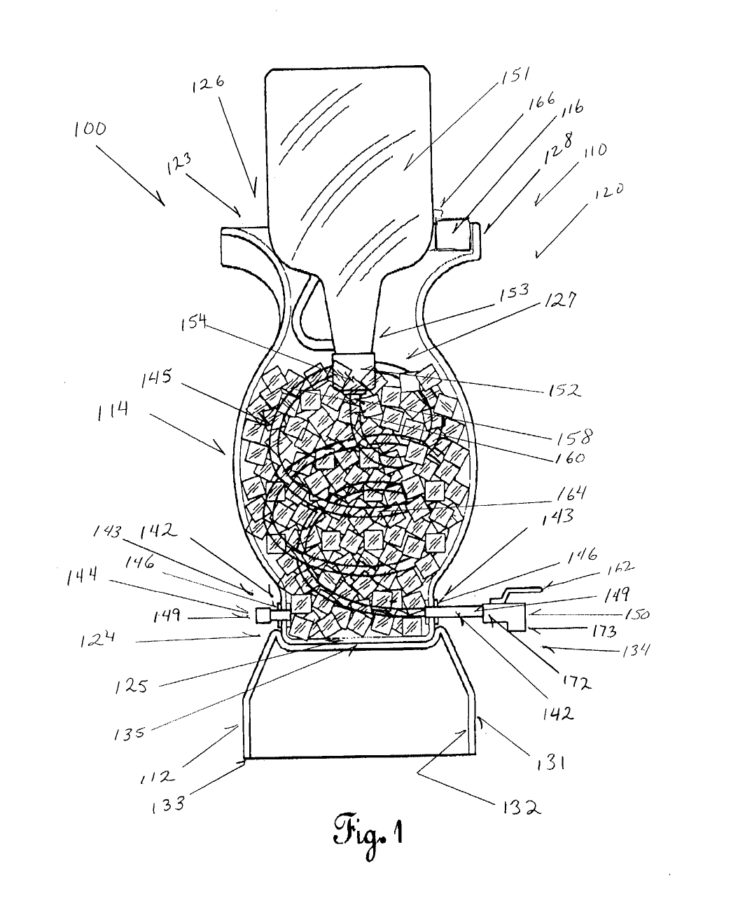

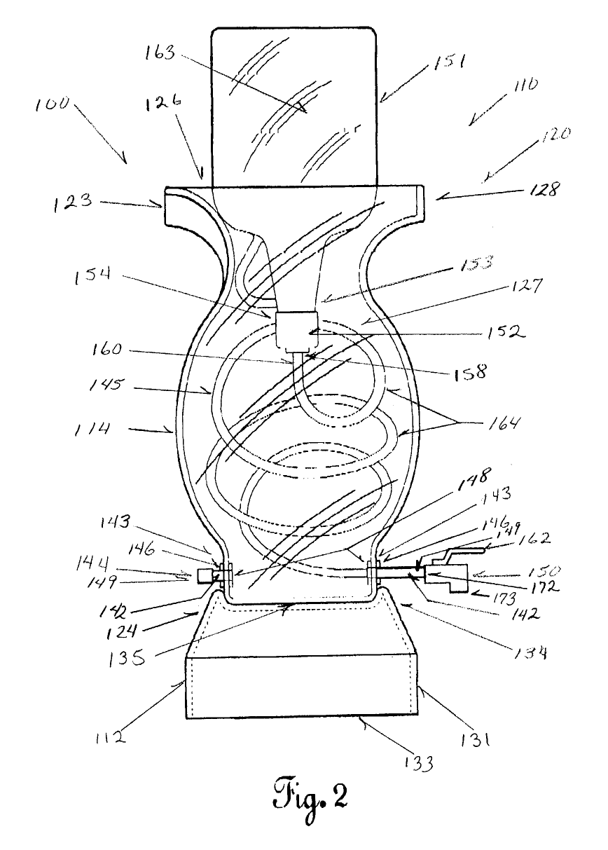

As shown in FIGS. 1-4, a product dispenser 100 includes a housing 110 and at least one dispensing circuit 120. The housing 110 includes a base 112, a vessel 114 and a plurality of lids 116. The vessel 114 is a hollow container of any suitable material, such as glass or plastic. The vessel 114 includes a top end 123 and a lower end 124. The lower end 124 includes a flat circular face 125 that serves as a bearing surface. The top end 123 of the vessel 114 has an aperture 126 leading to an interior cavity 127. A lip portion 128 of the aperture 126 is formed to prevent the lids 116 from falling off of the vessel 114.

The interior cavity 127 of the vessel 114 is designed to hold thermal cooling media, such as ice, ice water baths or the like. The vessel 114 further includes a pair of spout apertures 143 located near the lower end 124 of the vessel 114. The location and quantity of the spout apertures 143 may vary dependent on the quantity of dispensing circuits 120 and the shape of the vessel 114. The spout apertures 143 are outfitted with a bushing 146 and a connection tube 142. The connection tube 142 is a short segment of rigid tubing that connects the interior cavity 127 of the vessel 114 to the environment exterior to the vessel 114. The bushing 146 is of any suitable material, typically a soft elastomeric material such as rubber. The connection tube 142 and the bushing 146 may be sealed with any suitable sealant, including RTV or silicone to prevent leakage.

The housing 110 further includes a cap 144, wherein the cap 144 may be installed on the connection tube 142 by a user. With the cap 144 in place, liquids cannot pass through the connection tube 142. When the cap 144 is removed, liquids are able to pass through the connection tube 142, therein providing a drain for the interior cavity 127 of the vessel 114. In this configuration, the user is able to fill and drain the interior cavity 127 of liquids at will. Solids larger than an interior diameter of the connection tube 142 will not pass through the opening.

The base 112 is a rigid component having an outer surface 131 and an inner surface 132. The base 112 is formed and trimmed to produce a flat side 133 where the inner surface 132 and the outer surface 131 come together. The flat side 133 allows the base 112 to rest on any flat or semi-flat surface such as a table or shelf. An upper end 134 of the outer surface 131 includes a depressed area 135 having a circular shape complementary to the flat circular face 125 of the lower end 124 of the vessel 114 for accepting the vessel 114. In an alternative embodiment, the flat circular face 125 of the vessel 114 and the depressed area 135 of the base 112 may be permanently bonded together through the use of a solvent weld or mechanical fasteners.

The dispense circuit 120 includes the product container 151 having a top end 153, a container cap 152, the dispense tubing 145, the connector tube 142 and a dispensing valve 150. The product dispenser 100 may be used with multiple dispensing circuits 120. In the preferred embodiment, a second dispense circuit 120 may be connected to the unused connection tube 142. The product container 151 enters the aperture 126 of the vessel 114 and may come to rest on the curved entrance of the aperture 126. The product container 151 may be the package media in which the product was purchased. In this case, the product container 151 may be used with either one lid 116 as shown in FIG. 1 or two lids 116 for product containers 151 that have a top end 153 smaller than an inner periphery 171 of the lid 116. Therein, the product dispenser 100 is able to accommodate virtually any size product container 151.

Alternatively, the product container 151 may be furnished as part of the product dispenser 100 to be filled with a desired product. The product container 151, typically a bottle, is a hollow structure having an interior chamber 163, and a portal 154 at the top end 153. In this case, the interior chamber 163 of the product container 151 is used to house product. The portal 154 then is used for filling the product container 151, as well as the removal of product.

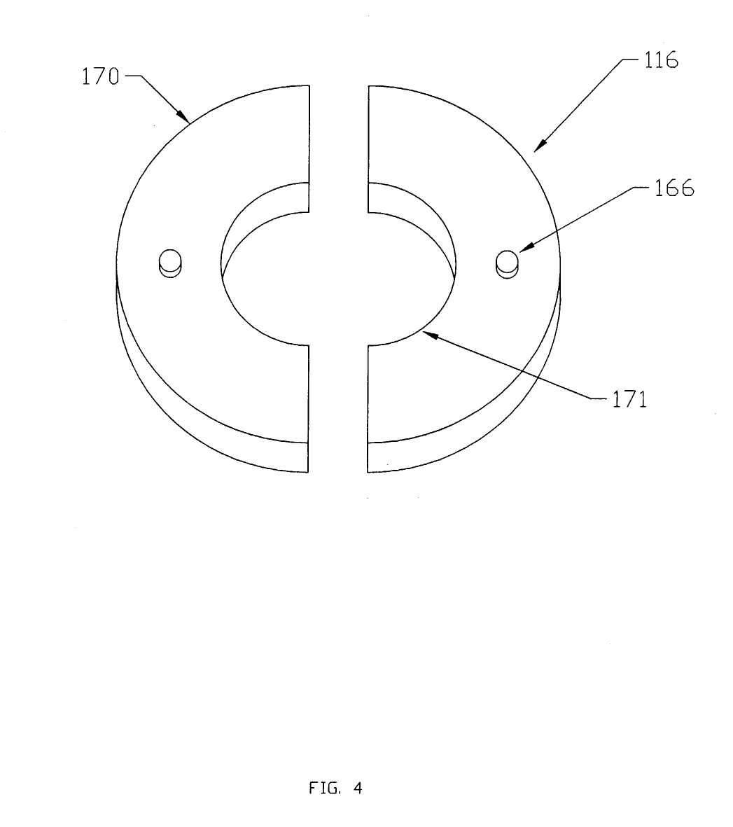

In the preferred embodiment, the lids 116 are in the shape of a half-circle, with a smaller concentric circle removed. Therein, the lids have an outer periphery 170 and an inner periphery 171. As shown in FIG. 4, the inner periphery 171 of each lid 116 comes together to form a passage for the top end 153 of the product container 151. With this design, the lids 116 may close out the area between the product container 151 and the vessel 114, therein insulating the interior cavity 127 from the ambient conditions. Each lid 116 may further include a knob 166 for handling during removal and installation. In cases where the top end 153 of the product container 151 does not fit within the passage, one lid may be used to partially support product container 151 as shown in FIG. 1.

The container cap 152 is an injection molded component having a hollow cylindrical shell 155 with a first end 156 and a closed end 157. The first end 156 is complementary to the portal 154 of the package container 151, wherein the portal 154 fits into the first end 156 of the container cap 152. This connection may be threaded, spring-loaded or a friction fit as required to prevent leakage. In an alternative embodiment, varying sizes of container caps 152 may be provided to accommodate different package containers 151.

The container cap 152 further includes a tubing aperture 158 that is connectable to a first end 160 of the dispense tubing 145. As such, product may flow from the interior chamber 163 of the product container 151, through the tubing aperture 158 of the container cap 152 and into the dispense tubing 145.

The dispense tubing 145 includes an inner passage 147 through which fluids may flow. The dispense tubing 145 is constructed of a flexible elastomer, in this preferred embodiment silicone, to allow for flexibility in the installation and removal of the product container 151. The dispense tubing 145 is of sufficient length to form a plurality of cooling loops 164 in the interior cavity 127 of the vessel 114. The cooling loops 164 increase the amount of surface area of the flowing product exposed to thermal cooling media as it passes through the dispense tubing 145. The dispense tubing is also of sufficient length to effectively chill the product as it passes from the product container 151 to a dispense point when the vessel 114 is filled with ice or other thermal cooling media.

A second end 161 of the dispense tubing 145 is connectable to an interior end 148 of the connector tube 142. The connector tube 142 passes through the bushing 146 and the spout aperture 143 in the vessel 114 wall. An outer end 149 of the connector tube 142 is connectable to an inlet port 172 of the dispensing valve 150 for product dispensing. The connection between the connector tube 142 and the dispensing valve 150 may be of any suitable means, including a friction fit, o-rings or the like. The dispensing valve 150 further includes a handle 162 for activating and deactivating the flow of product and an outlet port 173 for outflow of product. Switching the handle 162 to an on position provides an on demand dispense of a chilled product.

In summary, the product flowpath commences in the interior chamber 163 of the product container 151, passes through the container cap 152, through the inner passage 147 of the dispense tubing 145, through the cooling loops 164 of the dispense tubing145, through the connection tube 142 to the inlet port 172 of the dispensing valve 150, then exiting through the outlet port 173.

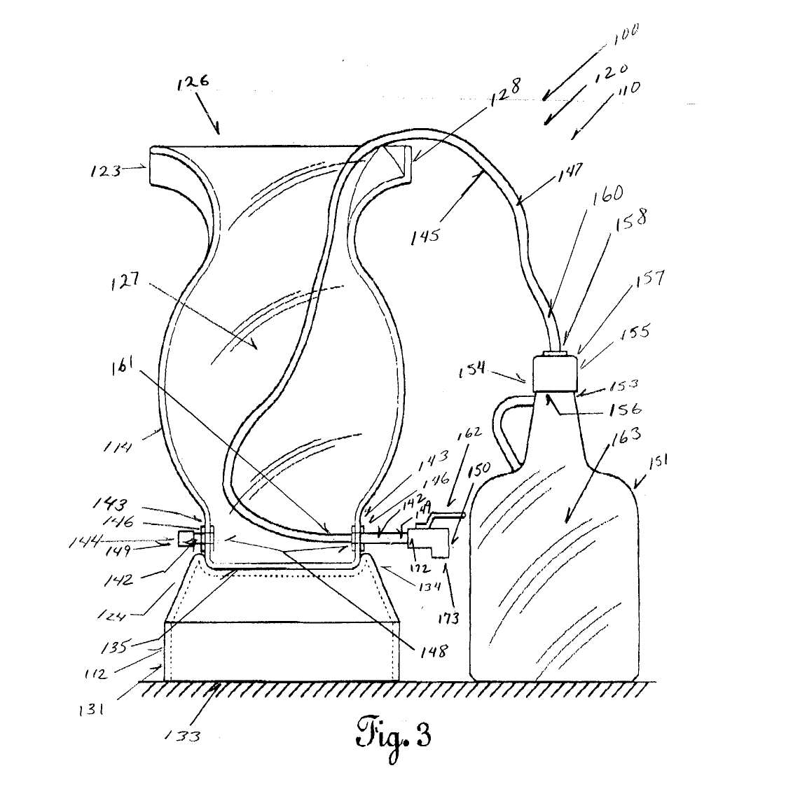

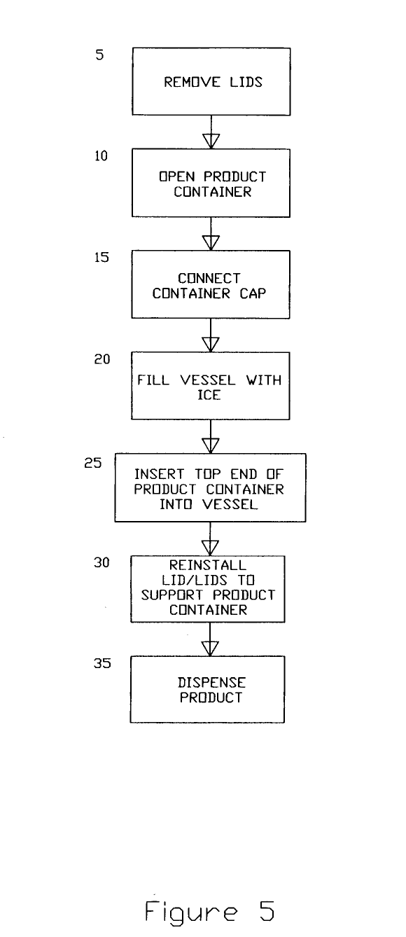

In use, a consumer must first remove the lids 116 to gain access to the interior cavity 127 of the vessel 114 as shown in step 5 of FIG. 5. Next, the consumer must open the product container 151, step 10. In step 15, the consumer must attach the container cap 152 to the product container 151, as shown in FIG. 3. At this point, the majority of the cooling loops 164 are inside of the interior cavity 127 of the vessel 114. . The user may now fill the vessel 114 with ice or other thermal cooling media, step 20. After connecting the container cap 152, the user must insert the top end 153 of the product container 151 into the aperture 126 of the vessel 114 until the product container 151 engages the vessel wall as shown in step 25. The user may then support the product container 151 with either one or both of the lids 116, step 30. The final resting place of the product container 151 is dependent upon the user, since the design of the vessel 114 will accommodate virtually any size product container 151. Step 30 provides for reinstalling the lids 116 onto the vessel 114 around the product container 151. The user may now dispense product as shown in step 35, by activating the handle 162.

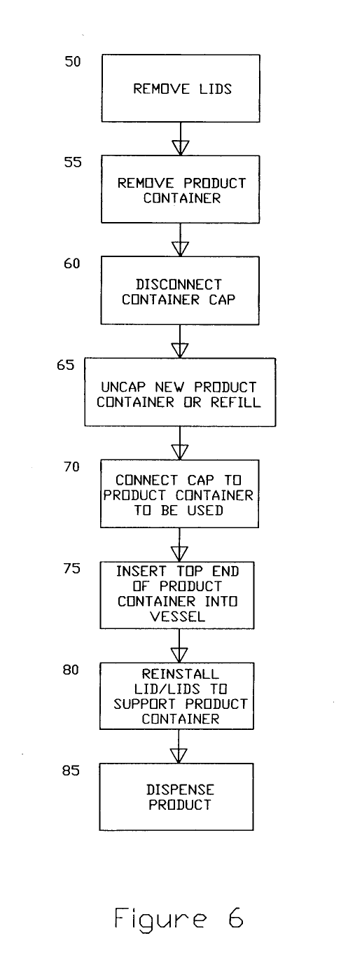

In the case of a product changeout, the user must remove the lids 116 as shown in step 50 of FIG. 6. The process continues with step 55 and the removal of the product container 151 to be changed. The user must then disconnect the container cap 152 from the product container 151, step 60. At this point, the new product package must be opened or alternatively, the product container 151 must be refilled, step 65. In step 70, the user must connect the container cap 152 to the product container 151 to be used. Once the cap 152 is connected, the user may insert the top end 153 of the product container 151 into the vessel 114 as shown in step 75. In step 80, the user reinstalls the lids 116 to further support the product container 151. The user may now dispense product, step 85, by activating the handle 162.

Should it become necessary to store the opened product container 151, the user must follow steps 50 through 60 of FIG. 6 to remove the product container 151 for storage. Should the thermal cooling media have melted, the user must remove the cap 144 from the connector tube 142 to the open position to allow the water to drain from the interior cavity 127 of the vessel 114.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

I claim:

1. A product dispenser comprising:
a housing adapted to receive a product container thereon and thermal cooling media therein;
a product container positioned on the housing;
a container cap attachable to a portal of the product container;
a dispense tubing coupled to the container cap and disposed within the housing; and
a dispensing valve mountable to the housing, and connectable to the dispense tubing to regulate delivery.

2. The product dispenser of claim 1, wherein the housing includes a vessel.

3. The product dispenser of claim 2, wherein the vessel includes an interior cavity.

4. The product dispenser of claim 3, wherein the housing includes an aperture leading to the interior cavity of the vessel.

5. The product dispenser of claim 4, wherein the interior cavity of the vessel houses the thermal cooling media.

6. The product dispenser of claim 2, wherein the housing includes a base.

7. The product dispenser of claim 6, wherein the vessel rests on the base.

8. The product dispenser of claim 4, wherein the aperture of the housing accepts a portal of the product container.

9. The product dispenser of claim 2, wherein the vessel is adapted to contain a liquid.

10. The product dispenser of claim 1, wherein the container cap includes an aperture therethrough.

11. The product dispenser according to claim 1, wherein the portal of the product container is connectable a first end of the container cap.

12. The product dispenser according to claim 1, wherein fluid passes from the product container through the dispense tubing to the dispensing valve.

13. The product dispenser according to claim 10, wherein the aperture of the container cap communicates with a first end of the dispense tubing.

14. The product dispenser according to claim 1, wherein the housing includes at least a single spout aperture for receiving the dispensing valve.

15. The product dispenser according to claim 14, wherein the spout aperture includes a connection tube to couple the second end of the dispense tubing to the dispensing valve.

16. The product dispenser of claim 5, wherein the dispense tubing is coiled into a plurality of cooling loops disposed within the interior cavity of the vessel.

17. The product dispenser of claim 1, wherein the housing includes at least a single lid.

18. The product dispenser of claim 1, wherein the lid is used to support the product container.

19. The product dispenser of claim 1, wherein the product container is part of product packaging.

20. The product dispenser of claim 1, wherein the product dispenser includes varying cap sizes to adapt to varying product container sizes.

21. A method of dispensing product, comprising:
a) connecting a first end of a container cap to an opened portal of a product container;
b) positioning the product container on a housing having dispense tubing disposed therein, wherein the dispense tubing is coupled with the container cap.
c) cooling the dispense tubing and its contents with thermal cooling media disposed in the housing; and
d) dispensing product from the product container via the dispense tubing and a dispensing valve coupled with the dispense tubing, wherein the dispensing valve is opened to permit product flow.

22. The method of claim 21, wherein the product container is part of product packaging.

23. The method of claim 21, wherein the product dispenser includes multiple sizes of the container caps to accommodate varying portal sizes.
